(19) United States
(12) Patent Application Publication
(10) Pub. No.: US 2009/0303158 A1
(43) Pub. Date: Dec. 10, 2009

(54) HEAD-UP DISPLAY SYSTEM

(76) Inventors: Nobuyuki TAKAHASHI, Shizuoka (JP); Kunimitsu Aoki, Shizuoka (JP); Masahiro TAKAMATSU, Aichi (JP); Kouji NOMURA, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/481,380

(22) Filed: Jun. 9, 2009

(30) Foreign Application Priority Data
Jun. 9, 2008 (JP) 2008-150231

(51) Int. Cl. G09G 5/00

(52) U.S. Cl. 345/7

(57) ABSTRACT

A head-up display system having a judgment boundary information storage storing judgment boundary information defining judgment area used for judging based on a movement of the driver's eye position whether or not a reflecting angle of the reflector is adjusted, an imaging device imaging an imaging area, an eye position detecting device detecting a driver's eye position in the imaging area based on image information imaged by the imaging device, a judging device judging whether or not a predetermined adjusting condition is satisfied when the eye position detected by the eye position detecting device is outside the judgment boundary, an install state determining device determining an install state of the reflector based on the detected eye position when the judging device judges that the adjusting condition is satisfied, and a reflector adjusting device adjusting the reflector to be in the determined install state.

### BACKGROUND OF THE INVENTION

1. Field of the Invention

The present invention relates to a head-up display system having a display unit and a reflector. The display unit emits indication lights of display information, and the reflector reflects the indication lights towards a projecting point of a projecting area on a windshield of a vehicle. The head-up display system superposes a virtual image of the display information projected on the projecting point of a projecting area on a foreground seen from the vehicle, such that a driver of the vehicle can recognize the virtual image and the foreground through the windshield simultaneously.

2. Description of Related Art

Recently, more or various information is required by a driver during operation of an automobile vehicle. Therefore, depending on type of information (such as urgent but little in amount), a head-up display (HUD) system has been applied at a driver's seat of an automobile vehicle, train and the like for virtually displaying the information on a windshield of the vehicle, so that the indicated information is superposed on a foreground seen from the vehicle through the windshield.

Such HUD system has a display unit disposed in an instrument panel of the vehicle. The display unit emits indication lights of an image, and a reflector such as a magnifying mirror reflects the indication lights towards a projecting point of a projecting area such as a windshield or a combiner of the vehicle, so that the image is projected as a virtual image on a display area (a projecting point of the projecting area). The virtual image is superposed on the foreground seen from the vehicle.

In the HUD system, a range of eye positions, which allow the driver to recognize the virtual image, is limited in a narrow area. Therefore, when the indication lights are not directed towards the eyes of the driver in such HUD system, the driver fails to recognize the superposed display information sufficiently. Since each driver has different eye positions due to a difference in their sitting heights, Japanese Patent Publication No. 2645487 proposes a HUD system having an adjusting member which adjusts a reflector's position, to allow a driver to adjust projecting direction of the indication lights to direct towards the driver, according to the adjustment made by the adjusting member.

A HUD system shown in Japanese Patent Published Application No. H11-67464 discloses a technology, in which brightness of display for a driver against brightness of external lights is automatically adjusted. Also, by presetting the preferred brightness initially with a light adjusting device, the brightness of display is automatically adjusted thereafter to the preferred brightness for the driver.

A HUD system shown in Japanese Patent Published Application No. H08-156646 discloses a technology, in which the driver's eye position is detected from an image by a camera, and a shift of the eye position from the center of the image is determined, and by adjusting an adjusting device based on the shift in position, an angle of a reflecting device is adjusted so that the center of the image is positioned closer to the eye position. Furthermore, a HUD system shown in Japanese Patent Published Application No. 2004-322680 discloses a technology, in which the driver's eye position is detected, and considering information of the position of the driver's eyes into information of distance between two cars, the projecting point of the HUD is adjusted.

In above-mentioned HUD systems, the projecting point could be adjusted in a vertical direction of a vehicle according to a driver's eye position. However, there are some cases in which the driver has difficulties of recognizing a virtual image which is adjusted for the driver in the vertical direction of the vehicle. The difficulties are caused by a change of the driver's posture (when caught in a traffic jam) or a change of a foreground seen through a windshield (background of the virtual image). Also when adjusting the projecting point of the virtual image according to the driver's eye position, the driver may feel troublesome for adjusting because their eyes are always moving during a drive. Therefore, for an improvement in recognition and in service for the driver during a drive, the above-mentioned problem was demanded to be solved.

In view of the above-mentioned problems, an object of the present invention is to provide a head-up display system to prevent a deterioration of the recognition of the virtual image caused by the changes of the driver's posture without troublesomeness for adjusting during a drive.

### SUMMARY OF THE INVENTION

For achieving the object, a head-up display system according to the present invention, as shown in FIG. 1, has a display unit 2 and a reflector 3. The display unit 2 emits indication lights L of display information, and the reflector 3 reflects the indication lights L towards a projecting point P of a projecting area E on a windshield of a vehicle. The head-up display system 1 superposes an image S of the display information, which is projected to the projecting point P of the projecting area E, on a foreground seen from a driver's eye position EP, such that the driver can recognize the virtual image and the foreground through the windshield simultaneously. The head-up display system includes; a judgment boundary information storage 7 storing judgment boundary information, which defines judgment area used for judging based on a movement of the driver's eye position EP in an eye range ER of the vehicle whether or not a reflecting angle of the reflector 3 is adjusted; an imaging device 4 imaging an imaging area C having the eye range ER; an eye position detecting device 61a detecting the driver's eye position EP in the imaging area C based on imaging information imaged by the imaging device 4; a judging device 61b making a judgment on whether or not a predetermined adjusting condition is satisfied when the eye position EP detected by the eye position detecting device 61a is outside the judgment boundary J defined by the judgment boundary information; an install state determining device 61c determining an install state of the reflector 3 based on the detected eye position EP when the judging device 61b judges that the adjusting condition is satisfied; and a reflector adjusting device 32 adjusting the reflector 3 to be in the install state determined by the install state determining device 61c.

Thus, when images of the imaging area C is imaged by the imaging device 4, based on imaging information (the images), the eye position detecting device 61a detects the driver's eye position EP in the imaging area C. When the eye position EP moves outside the judgment boundary J, if the judging device 61b judges that predetermined conditions, such as duration or number of times of the eye position moving outside the judgment boundary J, are satisfied, then the install state determining device 61c determines the install state of the reflector 3 based on the eye position EP. The reflector adjusting device 32 then adjusts the reflector 3 to be the determined install state. Thus, the indication lights L is projected on the projecting point P on a projecting area E corresponding to the eye position EP, even when the eye position EP is changed due to changes in the driver's posture.

Preferably, as shown in FIG. 1, the HUD system further has a judgment boundary information altering device 61d altering the judgment boundary information stored in the judgment boundary information storage 7 based on the adjustment made to the reflector 3 by the reflector adjusting device 32 so as to define the judgment area corresponding to the detected eye position EP.

Thus, when the reflector 3 is adjusted by the reflector adjusting device 32, the judgment boundary information stored in the judgment boundary information storage 7 is altered by the judgment boundary information altering device 61d, so that the information is altered to define the judgment boundary corresponding to the detected eye position EP. This enables to adjust the reflector 3 to be the install state corresponding to the changes in the driver's posture. Also, every adjustment of the reflector 3 for each change of the driver's posture and for slight change of the driver's posture can be prevented, so that frequent adjustment of the reflector 3 can be prevented.

As explained above, according to the present invention, difficulties of recognition of the virtual image caused by a change in the driver's posture, which cannot be solved by adjusting the virtual image in a vertical direction of a vehicle, can be solved by detecting the change based on the eye position change, and adjusting the install state of the reflector so that the indication lights are reflected at the reflecting position of the reflector which corresponds to the eye position. This prevents a deterioration of the recognition for the same driver during a drive. Therefore, the recognition is improved as well as a service for a driver during a drive, contributing to an improvement in commercial value of the head-up display system.

Also according to the present invention, the judgment boundary information is altered, based on the adjustment of the reflector, to the judgment boundary corresponding to the eye position EP. This enables to adjust the reflector to be in the install state based on the change in the driver's posture. Therefore, after the adjustment, the judgment can be made based on new judgment boundary information, reducing an annoyance to the driver while the adjustment is made by detecting the driver's eye position.

### BRIEF DESCRIPTION OF THE DRAWINGS

FIG. 1 is an illustration showing a basic construction of a head-up display system according to the present invention;

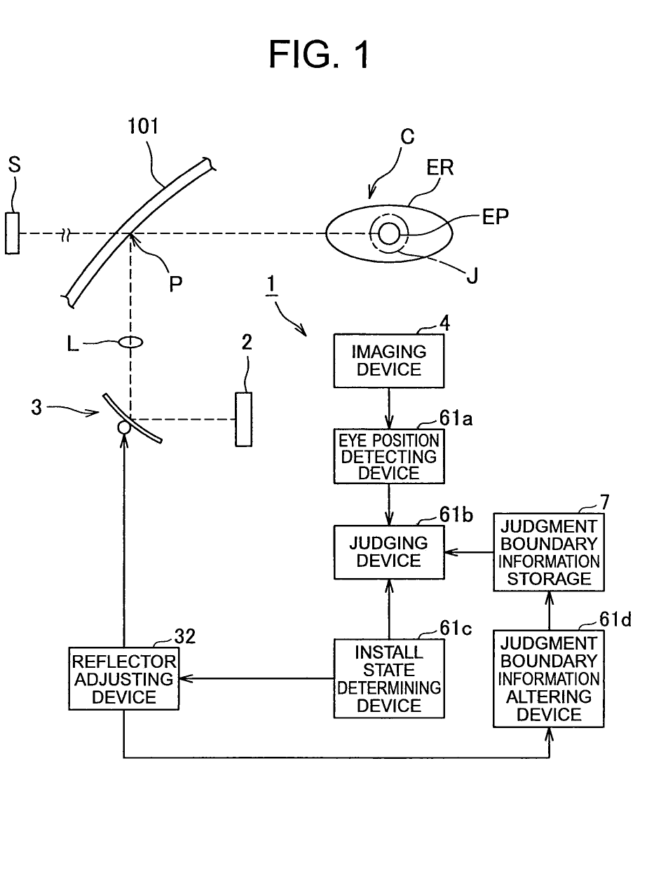

FIG. 2 is an illustration showing one example of concepts of the head-up display system according to the present invention;

FIG. 3 is an illustration showing one example of a relationship between a driver's eye position and a judgment boundary;

FIG. 4 is a flowchart showing one example of virtual image position adjustment processes executed by a CPU in FIG. 2; and

FIG. 5 is an illustration showing another example of the relationship between the driver's eye position and the judgment boundary.

### DETAILED DESCRIPTION OF THE PREFERRED EMBODIMENTS

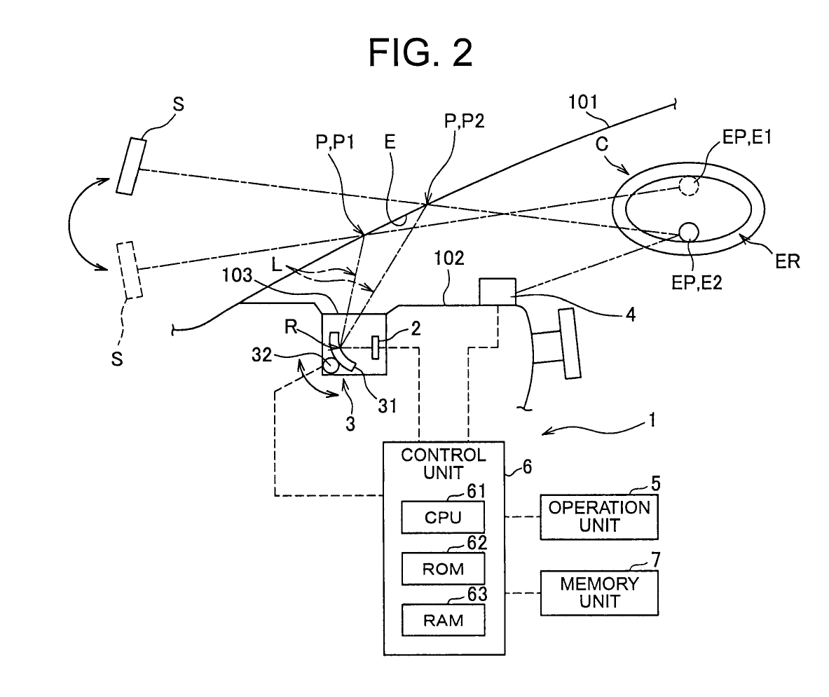

One embodiment of a head-up display system according to the present invention will be explained hereinafter in references to FIGS. 2 to 5.

A head-up display (HUD) system 1, as shown in FIG. 2, has devices other than an imaging device 4 inside an instrument panel 102 provided below a windshield of a vehicle 101.

An indication lights L of the HUD system 1 is recognized at a driver's eye position EP as a virtual image S of display information (such as images) projected on a projecting point P of a projecting area E of the windshield 101 through an opening 103 of the instrument panel 102. The virtual image S is then superposed on a foreground seen through the windshield 101 from the vehicle at the driver's eye position EP. In this embodiment, the projecting area E is an inner surface of the windshield 101, however, the present invention is not limited to this, and various embodiments can be adopted, for example, the projecting area E can be a surface of a publically known combiner and the like.

Such HUD system 1 is structured with a display unit 2, a reflector 3, an imaging device 4, an operation unit 5, a control unit 6 and a memory unit 7. The display unit 2, the reflector 3 and the control unit 6 are, for example, put into a case or the like and provided inside the instrument panel 102.

A light emitting device (for example, a field emission display, a fluorescent indicator, or an electro-luminescence display), or a liquid-crystal display with a back illumination light or the like can be used for the display unit 2. The display unit 2 is provided in the instrument panel 102 so that it emits the indication lights L through the opening 103 towards the projecting point P of the projecting area E. The opening 103 is formed at the instrument panel 102 into a slit extending in the direction of a vehicle width (hereafter referred as a lateral direction). The display unit 2 is controlled by the control unit 6 to indicate desired display information and emit the indication lights L. The display information includes, for example, arbitrary data such as image data, guiding data and/or index data.

The reflector 3 is structured with a mirror 31 and an adjusting device 32 adjusting the mirror 31. The mirror 31 is opposed to the display unit 2. A reflecting mirror, a magnifying mirror or the like are used arbitrary for the mirror 31. The mirror 31 is supported by a rotation shaft so it is rotatable within a rotation range predetermined by limit members and such (not shown), so that a reflecting angle can be adjusted to reflect the indicating beams L of the display information, which is indicated by the display unit 2, towards an arbitrary point within an eye range ER, which indicates a range in which the virtual image S can be recognized by the driver even when the driver's eye position EP is moved.

In order to adjust the reflecting angle, which is an angle of the indication lights L with respect to the projecting area E, along a vertical direction of the vehicle, the reflector adjusting device 32 has a rotating part (not shown) which rotates and moves the rotation shaft to an arbitrary direction, and a lateral move part (not shown) which moves the mirror 31 in the lateral direction (direction along the vehicle width). The reflector adjusting device 32 is electrically connected to the control unit 6. In this embodiment, the reflector adjusting device 32 driven by the control unit 6 functions as the reflector adjusting device described in claims.

The rotating part has, for example, a motor to rotate and move the rotation shaft fixed to the mirror 31, a drive circuit to drive the motor, and an angle signal output device to output an angle signal according to a rotation angle of the rotation shaft. The lateral move part has a movement structure to move at least the mirror 31 and the display unit 2 in the lateral direction, and a drive device to drive the movement structure. A structure moving (sliding) the rotation shaft of the mirror 31 in the lateral direction and such is adopted as the movement structure.

The reflecting angle and the position in the lateral direction of the mirror 31 are adjusted by the control unit 6, and as a result, the reflector 3 with above-mentioned structure allows the indication lights L from the display unit 2 to be reflected at a desired reflection point R. Thus, each of a plurality of the reflection points R on the mirror 31 corresponds to each of a plurality of projecting points P of the projecting area E of the windshield respectively.

A stereo camera, a video camera or the like are used arbitrary for an imaging device 4. The imaging device 4 is provided on the instrument panel 102 and such, so that the imaging area C with the eye range ER which is predetermined per vehicle can be imaged. In different embodiments, the imaging device 4 can be provided at various places like a room mirror or a combination meter. Also the imaging area C is defined as a three-dimensional space which has the eye range ER and can take image of the driver's eye (the iris of the eye).

A stereo camera has a first imaging device and a second imaging device, as publically known, and a synchronization device is connected to both imaging devices so that the imaging devices take the same imaging area C in synchronization. Imaging information (image data and such) taken by the first and the second imaging devices is then outputted to the control unit 6. The first and the second imaging devices, in which inner parameters and their relative positions are known, are synchronized with the synchronization device to take imaging information (images) including the driver's eye position EP in the imaging area C.

The operation unit 5 is electrically connected to the control unit 6 and has a plurality of operation switches to allow a driver to input and select various data. The operation unit 5 outputs operation signals corresponding to the operation made by the operation switches to the control unit 6. The operation unit 5 is provided at the vehicle's front panel and such so it can be operated by the driver.

The control unit 6 has a microcomputer, which includes a publically known CPU (Central Processing Unit) 61, a ROM (Read Only Memory) 62 and a RAM (Random Access Memory) 63. The ROM 62 stores various programs so that the CPU 61 functions as an eye position detection device, a reflecting position determination device, a reflector adjusting device and a posture information collecting device. The RAM 63 stores data necessary for the CPU 61 executing various processes.

The ROM 62 also stores line-of-sight detecting program which detects an line-of-sight direction from the driver's eye position based on a pair of imaging information (images) inputted by the imaging device 4. Such line-of-sight detecting method is disclosed in Japanese Published Patent Application No. 2004-254960.

For example, correspondences between each of the pair of the imaging information are found for the iris and the white of the driver's eye in each of the synchronized pair of the imaging information, and then two-dimensional coordinates or three-dimensional coordinates of the iris or the white of the eye are calculated as the eye position EP. The three-dimensional coordinates are calculated based on the two-dimensional coordinates on the imaging information and the relative relationship of position of two cameras, therefore detecting accuracy can be improved by considering a seat position of the vehicle and/or angle of room mirrors, door mirrors and such. Then, coordinates of the center of the eye-ball and coordinates of the center of the iris of the eye are calculated based on the three-dimensional coordinates, and a line extending from the coordinates of the center of the eye-ball towards the coordinates of the center of the iris of the eye is detected as the line-of-sight direction. Thus, a point at which the line, e.g. the line-of-sight direction, intersects with the windshield 101 when extended towards the windshield 101, represents a recognition point recognized by the driver.

In the case of determining the recognition point with above-mentioned method, the projecting point P of the projecting area E suitable for the recognition point is determined, and programs and/or tables, determining an install state of the reflector 3 so that the indication lights are projected at the projecting point P, are stored in the ROM 62 in advance. The install state of the reflector 3 can be determined, for example, by determining directly from the eye position and the line-of-sight direction, or by canceling the shift between the recognition point and the actual projecting point P. The install state of the reflector 3 may vary with a structure thereof, and in the above-mentioned structure, the install state represents a reflecting angle and a position (in the lateral direction) of the mirror 31.

The memory unit 7 can maintain various stored data, even when an electric power supply is cut. A memory such as an electronically erasable and programmable read-only memory (EEPROM) may be employed for the memory unit 7. The memory unit 7 corresponds to the judgment boundary information storage described in claims and stores variety of information such as judgment boundary information.

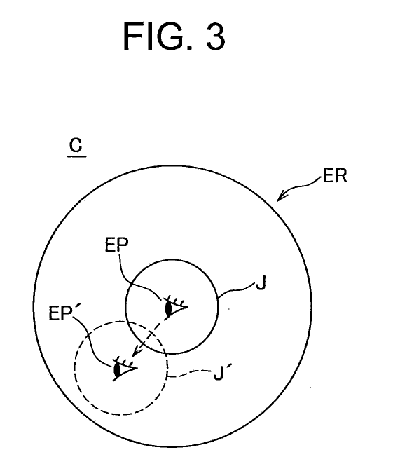

The judgment boundary information includes, as shown in FIG. 3 for example, various data, for the driver's eye position EP in the imaging area C, such as relative coordinates and/or area calculating equations for indicating a judgment boundary J, which is a judgment boundary corresponding to a driver or just a general judgment boundary. The judgment boundary J is set arbitrary based on a movement range and such of the driver's eye during a drive. Preferably, the judgment boundary J is set to fall within the eye range ER. The judgment boundary information defines a judgment boundary J set for the driver with arbitral timing, and based on the judgment boundary J, a judgment area used for judging whether or not to adjust the reflector 3 can be decided. Thus, in FIG. 3, area outside the judgment boundary J represents the judgment area.

In this embodiment, the judgment boundary J is explained as a circular area centered at the eye position EP, however, the present invention is not limited to this, but the judgment boundary J can be elliptic or square, or the center of the judgment boundary J can be determined arbitrary based on the movement range of the driver's eye position EP.

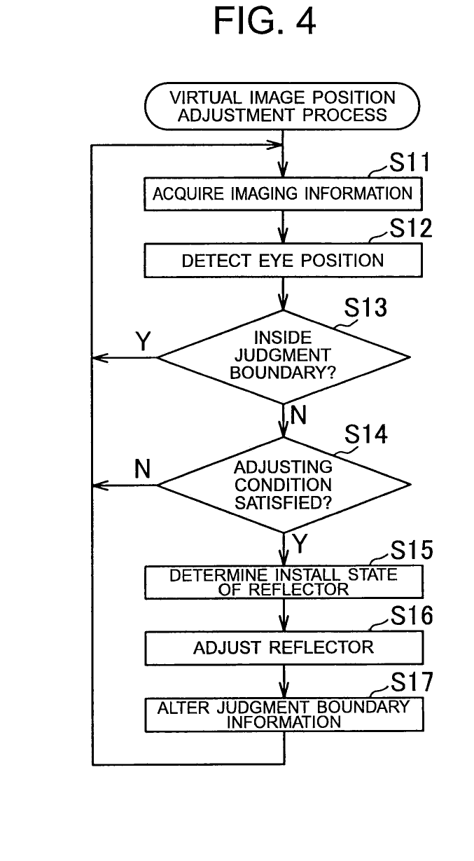

One example of virtual position adjustment processes executed by the above-mentioned CPU 61 is explained below in reference to the flowchart shown in FIG. 4. This process is premised to be started in response to start of the indication of the display unit 2, and to be ended forcedly in response to power off or shutdown command.

When the CPU 61 executes a virtual position adjusting process program, the imaging information is acquired from the imaging device 4 and stored sequentially in the RAM 63, as shown in step S11. Then in step S12, the above-mentioned line-of-sight detecting program is executed to detect the driver's eye position EP in the imaging area C based on a plurality of the imaging information stored in the RAM 63, and the driver's eye position EP is stored sequentially in the RAM 63. Then, the process is proceeded to step S13.

In step S13, the judgment is made on whether or not the eye position EP is inside the judgment boundary J, by comparing a plurality of the eye position stored sequentially in RAM 63 with the judgment boundary information stored in the memory 7. When the eye position EP is judged as positioning inside the judgment boundary J (Y in step S13), the process returns back to step S11 and a sequence of the processes is repeated. When the eye position EP is judged as positioning outside the judgment boundary J (N in step S13), then the eye position EP is considered as positioned in the judgment area and the process is proceeded to step S14.

In step S14, the judgment is made on whether or not the adjusting condition, which is defined by the adjusting condition information pre-stored in ROM 62, is satisfied. One example of the adjusting condition information is data structure indicating arbitrary decided adjusting condition including, for example; duration of the eye position EP in the judgment area and/or number of times the eye position EP enters in the judgment area. When the adjusting condition is not satisfied, (N in step S14), the process returns back to step S11 and a sequence of the processes is repeated. On the other hand, when the adjusting condition is satisfied, (Y in step S14), then the process is proceeded to step S15.

In step S15, the projecting point P of the projecting area E corresponding to the detected eye position EP is acquired, and the install state (state of reflecting angle and such) of the reflector 3 is determined so that the indication lights L are projected on the projecting point P. In step S16, the reflector 3 is adjusted to be in the determined install state by driving at least one of the rotating part and the lateral move part of the reflector adjusting device 32 of the reflector 3. In step S17, the judgment boundary information of the memory 7 is altered to the judgment boundary J corresponding to the detected eye position EP, and then the process returns back to step S11 and above sequence of the processes is repeated.

As explained above, by executing the virtual image position adjustment process shown in FIG. 3, the CPU 61 functions as an eye position detecting device, a judging device, an install state determining device and a judgment boundary information altering device described in claims. Furthermore, the eye position detecting device, the judging device, the install state determining device, and the judgment boundary information altering device described in claims correspond to step S12, steps S13 and S14, step S15, and step S17 respectively.

Next, an example of the movement (operation) of the HUD system 1 with above-mentioned structure is explained below in reference to the drawings such as FIG. 3.

When the driving driver's eye position EP is registered, for example by an initial setup, the HUD system 1 stores the judgment boundary information corresponding to the eye position EP in the memory unit 7. Then the HUD system 1, when started by the driver, displays the display information to the display unit 2 to project indication lights L, which is reflected at the reflector 3 adjusted to a desired angle by the driver, to the projecting point P of the projecting area E on the windshield 101. Thus a virtual image S of the display information is superposed on a foreground seen from the vehicle, such that the driver of the vehicle can recognize the virtual image and the foreground through the windshield 101 simultaneously.

The HUD system 1, as it starts the indication of the display unit 2, acquires the imaging information imaged by the imaging device 4 and detects the driver's eye position by executing the above-mentioned virtual position adjustment process. The HUD system 1 then detects the eye position EP moving outside the judgment boundary J to a new eye position EP′, as shown in FIG. 3. If the above-mentioned adjusting condition is satisfied, the HUD system 1 judges that the driver's eye position EP is changed largely to the new eye position EP′.

Based on the above-made judgment, the projecting point P of the projecting area E at which the virtual image S can be seen from the eye point EP′ is acquired. Then the install state (reflecting angle) of the reflector 3 is determined so that the indication lights L are projected on the projecting point P, and the reflector 3 is adjusted to be in the determined install state. As a result, the indication lights L from the display unit 2 is moved and projected on the projecting point P of the projecting area E corresponding to the new eye position EP′ resulted due to the driver's posture change. Therefore, the virtual image S is indicated at an indicating position suitable for the driver's posture, and recognition of the virtual image S by the driver can be improved.

The HUD system 1 also alters the judgment boundary information of the memory 7 based on the adjustment of the reflector 3, so that the judgment boundary information is altered to the judgment boundary J′ corresponding to the eye position EP′. After the alternation, the HUD system 1 monitors the eye position EP′ based on the new judgment boundary J′.

According to the above-explained HUD system 1, difficulties of recognition of the virtual image S caused by a change in the driver's posture, which cannot be solved by adjusting the virtual image in a vertical direction of a vehicle, can be solved by detecting the change based on the eye position change and adjusting the install state of the reflector 3 so that the indication lights are reflected at the reflecting position of the reflector which corresponds to the eye position. This prevents a deterioration of the recognition for the same driver during a drive. Therefore, the recognition is improved as well as a service for the driver during a drive, contributing to an improvement in commercial value of the head-up display system 1.

According also to the above-explained HUD system 1, the judgment boundary information is altered to the judgment boundary corresponding to the eye position EP based on the adjustment of the reflector 3. This enables to adjust the reflector to be in the install state based on the change in the driver's posture. Therefore, after the adjustment, the judgment can be made based on new judgment boundary information, reducing an annoyance to the driver while the adjustment is made by detecting the driver's eye position.

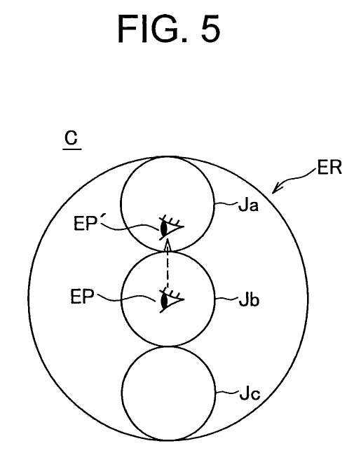

In the embodiment mentioned above, it is explained that in a HUD system 1, as shown in FIG. 3, judgment boundary J is altered within an eye range ER based on an eye position EP, however, the present invention is not limited to this embodiment, but the HUD system can, for example, judge whether or not to adjust an install state of a reflector 3 based on a predetermined plurality of the judgment boundaries (for example three judgment boundaries) Ja, Jb and Jc as shown in FIG. 5.

For example, the judgment boundary information is structured with three judgment boundaries Ja, Jb and Jc shown in FIG. 5. When the eye position EP originally positioned inside the judgment boundary Ja moves outside the judgment boundary Ja to an eye position EP′, and if the above-mentioned adjusting condition is satisfied, then the HUD system 1 adjusts the reflector 3 to be in the predetermined install state of the reflector 3 corresponding to the judgment boundary Jb. Also the HUD system 1 alters the judgment boundary Ja to the judgment boundary Jb and then monitors the eye position EP′. As explained, employment of the judgment boundaries Ja, Jb and Jc can achieve effect equivalent to the one achieved by the above-mentioned HUD system 1.

As explained above, the embodiments described herein only indicate the representative embodiments, and the present invention is not limited those embodiments. Various modifications and variations can be made within the scope of the gist of the invention described herein.

What is claimed is:

1. A head-up display system having a display unit and a reflector, wherein the display unit emits indication lights of display information, and the reflector reflects the indication lights towards a projecting point of a projecting area on a windshield of a vehicle, the head-up display system superposing an image of the display information, which is projected to the projecting point of the projecting area, on a foreground seen from a driver's eye position, so as to be recognized the image and the foreground through the windshield simultaneously, the head-up display system comprising:
a judgment boundary information storage storing judgment boundary information, which defines judgment area used for judging based on a movement of the driver's eye position in an eye range of the vehicle whether or not a reflecting angle of the reflector is adjusted;
an imaging device imaging an imaging area having the eye range;
an eye position detecting device detecting the driver's eye position in the imaging area based on imaging information imaged by the imaging device;
a judging device making a judgment on whether or not a predetermined adjusting condition is satisfied when the eye position detected by the eye position detecting device is outside the judgment boundary defined by the judgment boundary information;
an install state determining device determining an install state of the reflector based on the detected eye position when the judging device judges that the adjusting condition is satisfied; and
a reflector adjusting device adjusting the reflector to be in the install state determined by the install state determining device.

2. The head-up display system as claimed in claim 1, further comprising a judgment boundary information altering device altering the judgment boundary information stored in the judgment boundary information storage based on the adjustment made to the reflector by the reflector adjusting device so as to define the judgment area corresponding to the detected eye position.
